(19) United States
(12) Patent Application Publication
(10) Pub. No.: US 2019/0206247 A1
(43) Pub. Date: Jul. 4, 2019

(54) Smart In-Vehicle Decision Support Systems and Methods with V2I Communications for Driving through Signalized Intersections

(71) Applicants: Xiaofeng Xie, Rockville, MD (US); Zunjing Jenipher Wang, Rockville, MD (US)

(72) Inventors: Xiaofeng Xie, Rockville, MD (US); Zunjing Jenipher Wang, Rockville, MD (US)

(21) Appl. No.: 16/237,683

(22) Filed: Jan. 1, 2019

Related U.S. Application Data
(60) Provisional application No. 62/613,309, filed on Jan. 3, 2018.

(51) Int. Cl. G08G 1/09; G06N 7/00; G06N 20/00; G08G 1/0962

(52) U.S. Cl. CPC G08G 1/091; G06N 7/005; G05D 1/0088; G08G 1/0962; G06N 20/00

(57) ABSTRACT

Smart in-vehicle decision support system has been developed to address current challenges and offers a new approach to make right stop/go decisions for vehicles to drive through a signalized intersection. The methods and systems described herein exploit a novel conceptualization of the decision support problem as an integration process, where a decision support model takes advantages of vehicle-to-infrastructure communications and fuses the inputs from vehicles and intersection, which comprise key information of vehicle motion, vehicle-driver characteristics, signal phase and timing, intersection geometry and topology, and the definitions of red-light running, to explore a more complete variable space of physical and behavioral information and provide safer and more efficient decision supports to vehicles driving through a signalized intersection than the previous methods and systems. The novel formulation of the decision support model as a probabilistic sequential decision making process incorporates a set of decision rules that are responsible for different situations into the present invention, which enables each decision rule to quickly make a right decision and better improves both traffic safety and intersection throughput than the other existing formulations.

### CROSS-REFERENCE TO RELATED APPLICATIONS

This application claims priority to U.S. Provisional Application Ser. No. 62/613,309, titled SMART IN-VEHICLE DECISION SUPPORT SYSTEM FOR DRIVING THROUGH SIGNALIZED INTERSECTIONS WITH V2I COMMUNICATIONS, filed Jan. 3, 2018, incorporated by reference herein in its entirety.

### BACKGROUND OF THE INVENTION

The driving behavior of vehicles with regard to crossing a signalized intersection during the signal transition period has major impacts on safety and efficiency of transportation. The decision of a driver at the intersection is a binary decision process, i.e., the driver can either stop the vehicle before the stop line or let the vehicle go through the intersection. If a driver makes a decision to go while the situation is a “should-stop”, the vehicle ends up to a red-light running (RLR) or even more severe to a collision. In the USA, 709 people were killed and an estimated 126,000 of people were injured in the accidents involving RLR in 2014. If a driver makes a decision to stop while the situation is a “should-go”, the vehicle encounters more traffic delay, which not only wastes time and increases fuel consumption as well as emissions, but also more likely causes a rear-end collision. According to the report from the National Highway Traffic Safety Administration (NHTSA), about 40% of the total accidents are intersection-related crashes.

Among all possible factors resulting in the intersection-related crashes, the indecision zone at the intersection is one of the major causes. The indecision zone is defined at the onset of yellow light into two types. Type-I is called the Dilemma Zone (DZ) if the vehicle can neither make a comfortable stop nor pass the intersection without running the red light. Type-II describes the optional zone where both stopping and going can be performed, and the decision making by drivers can be inconsistent. In the indecision zone, making inappropriate or hesitant decisions could be prone since a driver has to make his decision during a short signal changing period from green to red and the decision-making process is complicated.

Concerning the indecision zone, many previous studies have focused on its inherent mechanism and model. About the driver-vehicle characteristics, research has been performed on the Perception-Reaction Time (PRT), the acceleration and deceleration characteristics. Two important parameters, the stopping distance and the clearing distance, have been proposed to determine the indecision zone. Decision making at the onset of yellow light has been estimated based on a set of predictor variables. Existing estimation methods include logistic regression, and the other methods based on the critical time and the comfortable acceleration. About the signal timings, study has been focused on the impacts of yellow interval duration. On the RLR definition, the Federal Highway Administration (FHWA) has referred to the two versions of laws on permissive yellow and restrictive yellow, and recently, the all-red extension used in the DZ protection might be seen as another unlimited version.

The design of protection methods handling the indecision zone and safety problem at an intersection has received considerable attention over the years. A common method is to hold the green light until the number of vehicles in the zone is lower than a threshold. Many other methods have focus on Advanced Warning Signs (AWS) providing more information and sending advisory messages rather than making decisions for drivers, such as sending warning coupled with advisory speed limit to drivers at the onset of yellow light. In addition, to discourage RLR, red light camera enforcement has been evaluated in a number of studies to demonstrate its significant safety benefit in reducing risk of right-angle crashes, though it may have a mixed effect on the risk of rear-end crashes. A few other methods have aimed to protect the vehicles in RLR, such as the methods using all-red extension to help a vehicle in RLR to pass the intersection with as much safety as possible.

Other recent work has focused on designing in-vehicle systems to handle the indecision zone and safety challenges at an intersection. Supported by Internet of Things (IoT) technologies, a typical in-vehicle system can not only provide vocal or visual warnings but also connect with the intersection through Vehicle-to-Infrastructure (V2I) communications, such as the 4G Long-Term Evolution (LTE) and Dedicated Short Range Communications (DSRC). Each of the existing in-vehicle systems has been designed to work for some special condition. For example, the Avoiding DZ and Warning system (ADZW) has been proposed for predicting DZ and clearance zone at the onset of yellow, and the system does not use the yellow and red time in Signal Phase and Timing (SPaT). There was an in-vehicle system warning drivers when the vehicle need to stop based on two simple conditions: (1) the remaining green time is four seconds or more; and (2) the vehicle cannot clear the intersection without acceleration. The LBS-based DZ Warning System (DZWS) has been proposed to estimate dilemma zone and alarm drivers for the condition at the onset of yellow light, by using the information including vehicle position and speed, yellow interval, intersection width, communication delay and PRT. In addition, none of existing single system is able to work on different RLR definitions.

### BRIEF SUMMARY OF THE INVENTION

Among all possible factors impacting safety and efficiency of transportation, the indecision zone problem at an intersection presents a major challenge to drivers and vehicles, which is with regard to making a stop/go decision while crossing a signalized intersection during the signal transition period. The stop/go decision-making process in an indecision zone is challenging for a vehicle approaching an intersection, as the decision has to be made during a short signal changing period and is corresponding to an optimization in a rather complicated space of variables that comprise all relevant information of driving as well as environment and, moreover, some information needed for making right decisions are often lacking or inaccurate to driver or vehicle. The present invention is a smart in-vehicle decision support system (referred to herein as SIV-DSS) that addresses these challenges and offers a new approach to make right stop/go decisions for vehicles approaching a signalized intersection. The methods and systems described herein exploit a novel conceptualization of the decision support problem as an integration process, wherein a decision support model takes advantages of vehicle-to-infrastructure communications and fuses the inputs from vehicles and intersection comprising key information of vehicle motion, vehicle-driver characteristics, signal timings, intersection geometry and topology, and the definitions of red-light running to explore a more complete variable space of physical and behavior information and provide safer and more efficient decision supports for vehicles driving through a signalized intersection than the previous methods and systems. The novel formulation of the decision support model as a probabilistic sequential decision making process incorporates a set of decision rules that are responsible for different situations into the present invention, which enables each decision rule to quickly make a right decision and better improves both traffic safety and intersection throughput than the other existing formulations.

### BRIEF DESCRIPTION OF THE DRAWINGS

For the present invention to be easily understood and readily practiced, the invention will now be described, for the purposes of illustration and not limitation, in conjunction with the following figures, wherein:

FIG. 1 is an illustration of the indecision zone problem as a vehicle approaches a signalized intersection during a signal transition period from green to red, wherein vehicle-to-infrastructure (V2I) communication provides wireless exchange of data between the intersection/infrastructure and vehicles;

FIG. 2 illustrates one embodiment of the system diagram of the smart in-vehicle decision support system (SIV-DSS) of the present invention;

FIG. 3 illustrates one embodiment of the probabilistic sequential decision making process (PS-DMP) of the decision support model (DSM) in the smart in-vehicle decision support system (SIV-DSS) of the present invention;

FIG. 4 lists examples of the realization of decision rule instances of the present invention;

FIG. 5 lists examples of PS-DMP cases of the decision support model (DSM) of the present invention;

FIG. 6 illustrates one embodiment of the realization of the smart in-vehicle decision support system (SIV-DSS) of the present invention, wherein all the labels in FIG. 2 are reused for the same components, and the motion state (V) is produced at each decision time t_{D} by the vehicle-side processor (F in FIG. 2);

FIG. 7 is a logic flow diagram of one embodiment of the probabilistic sequential decision making process (PS-DMP) of the present invention;

FIG. 8 is a logic flow diagram of one embodiment of the decision rule instance R1 of the present invention;

FIG. 9 is a logic flow diagram of one embodiment of the decision rule instance R2 of the present invention;

FIG. 10 is a logic flow diagram of one embodiment of the decision rule instance R3 of the present invention;

FIG. 11 is a logic flow diagram of one embodiment of the decision rule instance R4 of the present invention;

FIG. 12 is a logic flow diagram of one embodiment of the decision rule instance R5 of the present invention;

FIG. 13 is a logic flow diagram of one embodiment of the method for calculating expected values tt₀, x₀, and v₀ at t=0 of the present invention;

FIG. 14 is a table showing one example of performance analysis of the decision support models (DSMs) of the present invention, wherein the default parameters and variants are used and the results are shown in percentages (%);

FIG. 15 is a graph showing one example of the comparison of the results between CDP and CDPt of the present invention;

FIG. 16 is a table showing one example of performance analysis of CDPt of the present invention, wherein different driving behavior modes are used and the results are shown in percentages (%);

FIG. 17 is a table showing one example of performance analysis of CDPt of the present invention, wherein different T_{CD}, Y, and R values are used and the results are shown in percentages (%);

FIG. 18 illustrates one example of performance analysis of the present invention on the minimal Y and maximal τ durations to achieve zero RLR probability;

FIG. 19 illustrates one example of the results of the actual stopping probability \hat{P}ₛₜₒₚ(t) of the CDPt decision support model of the present invention, wherein different settings are used for the vehicles approaching the intersection with different remaining green time t ∈ [0, \tilde{t}t]. All figures are only plotted in the range t ∈ [0, 5] for a better resolution since \hat{P}ₛₜₒₚ(t)=0 for t ∈ [5, \tilde{t}t]; and

FIG. 20 illustrates one example of the results of the cumulative distribution function \hat{F}ᵣₑₗ for the vehicles passing through the intersection at different relative time (tᵣₑₗ) related to RLR violation, using the CDPt decision support model of the present invention and different settings. Negative value of relative time means the duration where RLR violation occurs. The CDFs do not reach 1 at the end since the pStop for stopping vehicles is not included.

### DETAILED DESCRIPTION OF THE PREFERRED EMBODIMENTS

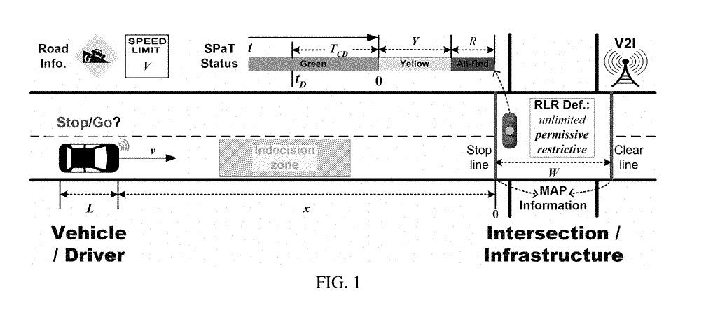

FIG. 1 shows the generic illustration of the indecision zone problem of a vehicle moves on a road passing through a signalized intersection. Some information is known about the intersection and associated infrastructure. The intersection geometry and topology (i.e. MAP) contains the location information of the stop line and the clear line for each entry movement, etc. The intersection width W is the distance between the stop line and the clear line. On the Signal Phase and Timing (SPaT) of the traffic light, let t be the remaining green time, T_{CD} be the green countdown time, Y represent the yellow interval, and R represent the all-red interval. The green countdown time is a virtual concept meaning that T_{CD} is known (T_{CD}≥0) earlier before the onset of yellow, although the green time could be variable before t=T_{CD}. The road information contains the speed limit V, the grade G, and other road conditions on the approach road. Each vehicle follows a specific definition of red-light running (RLR) according to the local law, as crossing the intersection. On the vehicle, let v be the moving speed, x denote the distance of the vehicle from the stop line, and L be the length of the vehicle. Each vehicle can communicate with the intersection infrastructure through wireless V2I communications to obtain all available information.

For convenience, the stop line is set as the origin point of x, and the onset of yellow light is set as the origin point of t, as shown in FIG. As time goes on, both x and t can be decreased to negative values. The traffic light is in the yellow phase as t ∈ [−Y, 0], and in the all-red phase as t ∈ [−(Y+R), −Y]. The vehicle crosses the stop line as x<0, and completely leaves the clear line of intersection as x<−(W+L) .

Let the real-time vehicle motion state be (t,x, v) at each t. Initially, x>0 and v>0. For safety, v≥0 is assumed during the whole driving process, i.e., the vehicle is not allowed to drive reversely. As approaching the intersection around the signal transition period, the driver of the vehicle has to make a decision in the binary choice set {stop, go }: either to bring the vehicle to a full stop behind the stop line, i.e., x>0 and v=0, or to go beyond the clear line of the intersection, i.e., x<−(W+L) and v>0.

During the time around the onset of yellow light, there is an indecision zone that drivers could be prone to make inappropriate or hesitant decisions. As described in the background of the invention, the indecision zone is one of the main factors causing those accidents at signalized intersections, such as the rear-end and right-angle collisions. The present invention is a smart in-vehicle decision support system (referred to herein as SIV-DSS) to solve the indecision zone problem, which supports driver or vehicle to make a better stop/go decision at the decision time t_{D} (t_{D} ∈ (−Y+τ, T_{CD}]), and improves both traffic safety and efficiency of transportation.

### Variables and Acronyms

W: the intersection width (m), i.e, the distance between the stop and clear lines

Y: the duration of the yellow light (s), or yellow change interval

R: the duration of all-red light (s), or all-red clearance interval

T_{CD}: the duration of green countdown time (s)

t: the remaining green time to the onset of yellow indication (s)

t_{D}: the time starting to execute the decision support model (DSM), i.e., the decision time (s)

x: the distance to the stop line of the intersection (m)

v: the approaching speed (m/s)

tt: the travel time to the stop line (TTSL) (s)

V: the posted speed limit (m/s)

L: the length of the vehicle (m)

τ: the perception-reaction time (PRT), or the perception response time (s)

a: the comfortable acceleration rate on level pavement (m/s²)

d: the comfortable deceleration rate on level pavement (m/s²)

G: the grade of the approach road (in percentage)

g: the acceleration due to gravity (9.81 m/s²)

AWS: Advanced Warning Signs

CAN: Controller Area Network

DSM: Decision Support Model

DSRC: Dedicated Short Range Communications

DZ: Dilemma Zone

GPS: Global Positioning System

LTE: Long-Term Evolution wireless communication

MAP: Intersection Geometry and Topology

NTCIP: National Transportation Communications for Intelligent Transportation System Protocol

PRT: Perception-Reaction Time

PS-DMP: The Probabilistic Sequential Decision Making Process

RLR: Red-Light Running

SIV-DSS: Smart In-Vehicle Decision Support System

SPaT: Signal Phase and Timing

V2I: Vehicle-to-Infrastructure

V2X: Vehicle-to-Everything

### System Design

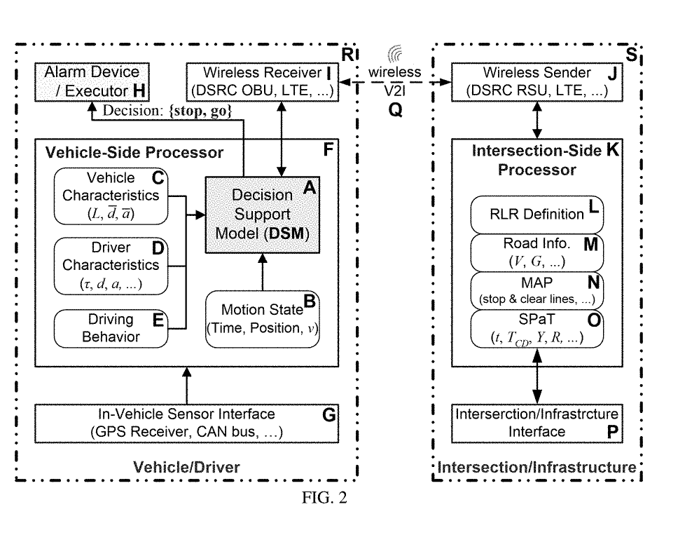

FIG. 2 shows the system diagram of the Smart In-Vehicle Decision Support System (SIV-DSS), including the Decision Support Model (DSM) A and the inputs of the in-vehicle stopping decision support system. The DSM is able to make the decision of {stop, go} by using all available information from both the vehicle/driver R and the intersection/infrastructure S. Using the alarm device/executor H, the final decision from the DSM can be provided as an alarm (e.g., vocally and visually) to the human driver, or automatically executed in autonomous vehicles. Note that in an fully autonomous/self-driving vehicle, the driving is controlled by an artificial intelligence (AI) or robotic operating system, which can be seen as a virtual driver.

The intersection-side processor K (see the right side of FIG. 2) maintains and retrieves SPaT, MAP, the road information, and the RLR definition using its memory and the intersection/Infrastructure interface P. SPaT (O in FIG. 2) comprises the information of t, Y, R, and T_{CD}. MAP (N in FIG. 2) comprises the locations of the stop line and the clear line to obtain the intersection width W. The road information (M in FIG. 2) comprises the speed limit V and the grade G. The RLR definition (L in FIG. 2) is specified according to the local law on red-light running violation.

The vehicle-side processor F (see the left side of FIG. 2) not only hosts the DSM A, but also maintains the important information to the DSM. The raw vehicle motion state inputs B include the current time, the vehicle velocity, v, and the vehicle position. The distance from the vehicle to the stop line of the intersection, x, can be calculated from the vehicle position and the position of stop line in the MAP information. The vehicle characteristics C include the vehicle length L, the maximum acceleration rate ã, and the maximum deceleration rate \tilde{d}, etc. Based on the driver characteristics D and driving behavior E, the vehicle can either try to cross the intersection by applying as much as a comfortable acceleration rate a≤ã to the vehicle, or try to stop behind the stop line by applying as much as a comfortable deceleration rate d≤\tilde{d} to the vehicle, after the period of the perception and reaction time τ. These information (B, C, D and E) are maintained and retrieved using the memory of F and the in-vehicle sensor interface G.

Herein we briefly describe how the inputs are obtained in the real world. The vehicle position and speed can be obtained from the in-vehicle sensor interface G with the high-precision Global Positioning System (GPS) receiver, or via a fusion on the data retrieved from the Controller Area Network (CAN bus). The SPaT information can be obtained from the intersection/infrastructure interface P, e.g., the traffic controller connected with the NTCIP or proprietary protocols. For T_{CD}, some traffic lights around the world have built-in supports, e.g., flashing the green light or illuminating the yellow light for a few seconds before the end of green. If the intersection is in a fixed-time control, the T_{CD} is the whole green time. Instead, if the intersection is in an adaptive control, the T_{CD} could be a short interval. If the whole green time duration is totally variable, then T_{CD}=0. The RLR definition, MAP and the road information can be specified locally. The parameters of the vehicle characteristics are either known or learnable. The parameters of the driver behavior and characteristics can be learned from the historical and real-time data. Using wireless sender and receiver (J and I), the V2I communications (Q in FIG. 2) between the intersection/infrastructure S and the vehicle R can be realized in different forms, such as 4G/LTE/5G cellular communications or DSRC communications (from a roadside unit (RSU) at the intersection to an on-board unit (OBU) in the vehicle). The output information of DSM can be shown with an alarm device to human drivers or be fed to an executor of autonomous vehicle. Notice that one physical device can host the functions of several components. For example, an RSU can work as the role of the intersection-side processor; an OBU can function as both the vehicle-side processor and the GPS receiver; and a mobile phone can function as the GPS receiver, the 4G/LTE/5G receiver, the vehicle-side processor, and the alarm device.

### RLR Definition

On red light running (RLR), there are several possible definitions without compromising the safety. In the restrictive mode, violation occurs if the vehicle has not cleared the intersection after the onset of red. In the permissive mode, violation occurs if the vehicle enters the intersection after the onset of red. The restrictive and permissive modes are used as the law in many states. In the unlimited mode, violation occurs if the vehicle has not cleared the intersection after the end of the all-red interval. The last mode might be the foundation of the dynamic all-red extension strategy.

For each motion state (t,x, v), let Tᵣₑₘ(t) and Xᵣₑₘ(x) respectively be the remaining time and distance to arrive a required line without running the red light. For different RLR modes, they can be calculated as

$$\begin{matrix}{T}_{rem} ( t ) = \{ \begin{matrix}t + Y + R , & IF RLR mode ∈ \{ unlimited \} \\ t + Y & IF RLR mode ∈ \{ permissive , restrictive \}\end{matrix} & ( 1 ) \\ {X}_{rem} ( x ) = \{ \begin{matrix}x + W + L , & IF RLR mode ∈ \{ unlimited , restrictive \} \\ x & IF RLR mode ∈ \{ permissive \}\end{matrix} & ( 2 )\end{matrix}$$

Let the relative time tᵣₑₗ=Tᵣₑₘ(t), in which t is the time as the vehicle is at the motion state (t, x, v) with Xᵣₑₘ (x)=0. For a vehicle that passes through the intersection, the vehicle is considered as running the red light if tᵣₑₗ<0, and if so, the absolute value |tᵣₑₗ| is the duration of RLR violation.

### Driver Characteristics

Major driver characteristics comprise Perception and Reaction Time (PRT) and acceleration and deceleration rates.

### Perception and Reaction Time (PRT)

For a driver, the Perception and Reaction Time (PRT) is defined as the time interval from the appearance of some situation in the field of view to the initiation of a reaction by the driver. PRT is often broken down into the four components referred to as the perception, intellection, emotion, and volition (PIEV) time or process. Traditionally, PRT has often been applied to the decision process of a driver at the onset of yellow light. It was found that the observed PRT data follow a log-normal or similar distributions. Based on the observed behavior of drivers in unexpected events, the standard of American Association of State Highway and Transportation Officials (AASHTO) allows PRT to be 2.5 s, which includes 1.5 s for perception and 1.0 s for reaction. In a field study, the 50th and 85th percentile brake-response times for first-to-stop vehicles were respectively 1.0 and 1.6 s, and the maximum response time was more than 3.0 s.

In our setting, the decision support model can provide the advisory decision since the start of green countdown time, and the alarm may be provided visually or vocally. In the presence of countdown timer, the 50th and 85th percentile brake PRTs were respectively 1.2 and 2.52 s, and the maximum response time is more than 4.0 s. A recent study showed that when using a voice alarming and driving at a velocity of 60, 80 and 100 kph, the PRT time required by the 85th percentile of drivers is respectively 1.004, 1.084 and 1.120 s only.

### Acceleration and Deceleration

The practical acceleration and deceleration rates in the driving behavior come from the models mixing both the vehicle and the driver characteristics.

For deceleration, we assume that every driver applies comfortable braking, and the vehicle is eventually slowed down with a comfortable deceleration rate d. For varying vehicle velocity, the constant deceleration has been used in the existing models, and has been shown in the field data.

There are different values of the comfortable deceleration rate on a level pavement. According to AASHTO, it was assumed to be 3.41 m/s² (11.2 ft/s²). A slightly more conservative value of 3.0 m/s² is used in, which is the default value defined in VISSIM. In another study, the 15th, 50th and 85th percentile deceleration rates for first-to-stop vehicles were respectively 2.19, 3.02 and 3.93 m/s².

A more general form of the comfortable deceleration rate D is represented as

D=min(\tilde{d},d)+G·g (3)

where G is the grade of the approach lane (in percentage), g is the acceleration due to gravity (9.81 m/s²).

If \tilde{d}≥d and G=0%, there is D=d, as used in most existing studies. If G is considered, there is D=d+G·g, as used in some work. For most vehicles and road surface conditions (e.g., dry, wet), the maximum deceleration rate \tilde{d} does not apply as a limitation since it is often much larger than the comfortable deceleration rate d for most drivers. However, \tilde{d} can be significantly lower in some inclement weather conditions, for example, \tilde{d} is reduced to 0.15 g on ice and 0.22 g on snow.

For acceleration, the availability of acceleration rate a can be described as a function of the current speed v. A general form of a(v) has been used for fitting the field data as:

1(v)=β₀^{acc}·exp(β₁^{acc}·v) (4)

where β₀^{acc} is the maximum comfortable accelerate rate that occurs at v=0, β₁^{acc}is negative, since the power to accelerate reduces at a higher speed. Normally, the maximum acceleration rate ã is factored into the value of β₀^{acc}. The default values of the coefficients β₀^{acc} and β₁^{acc} are respectively 1.70 and −0.04 for passenger vehicles. The acceleration rate is much lower for heavy vehicles (trucks).

For clarity of description, we ignore most of other driver features. For example, the actual acceleration rate a can be decided by the aggressiveness model, which reflects the probability of the vehicle running through the intersection with a velocity v≥V when stopping is a better decision. Some of the driver features, e.g., age, gender, and fatigue/distraction status, might be factored into the existing features.

### Driving Behavior

As a vehicle approaches a signalized intersection, its driving behavior can be described in two types, i.e., in the state of going and stopping. For stopping, different driving behavior modes do not change the delay, as long as the vehicle stops behind the intersection. Thus the vehicle can simply apply a constant deceleration rate to stop, as suggested in many existing work. Some stopping behavior modes might lead to eco-driving that reduces fuel consumption, but that is beyond the scope of this work.

In the state of going, each driver can have a comfortable speed range [V_{L}, V_{U}]. The vehicle will then be decelerated if v>V_{U} and be accelerated if v<V_{L}. Both V_{L} and V_{U} are associated with the speed limit V. In some study, the range is fixed as 1 m/s (i.e., 3.6 kph) according to V.

Next, we describe several rational driving behavior modes that are commonly used in literature to classify the driving behaviors in the state of going. In the cruising mode, the vehicle will remain a constant speed. In the random mode, the acceleration rate of the vehicle will vary in the range of [−a_{δ}, a_{δ}] at random to simulate the speed fluctuation. By default, a_{δ}=0.5 m/s². If a_{δ}=0 or is sufficient small, then the random mode is reduced into the cruising mode. In the acceleration mode, the vehicle keeps traveling with a comfortable acceleration using Eq. 4 until its speed reaches the upper bound V_{U}, after the perception and reaction time τ behind the decision time t_{D}. For other driving behaviors, the patterns might be estimated using time series methods, e.g., the Kalman filter, based on previous motion states.

Let the motion state be (t_{D}, x_{D}, v_{D}) at the decision time t=t_{D}. For each mode, the continuation distance in a given driving time duration t_{d} after the decision time can be calculated as X_{C} (t_{d}, v_{D}), where

$$XC ( {t}_{d} , v ) = \{ \begin{matrix}v \cdot {t}_{d} , & IF mode is cruising , \\ \overline{v} \cdot {t}_{d} , & IF mode is random , \\ v \cdot {t}_{d} + 0.5 \cdot {a}_{est} \cdot {t}_{a 2 u}^{2} + ( {V}_{U} - v ) \cdot {t}_{ub} , & IF mode is acceleration .\end{matrix} \qquad ( 5 )$$

where \tilde{v} is the estimated average speed for the random mode, aₑₛₜ is the estimated acceleration rate, tₐ₂ᵤ is the time required to accelerate to V_{U}, t_{ub} is the time driving in the speed of V_{U}. They are calculated as

v̅=0.5·(V_{L}+V_{U}),

aₑₛₜ=a (V_{U})

tₐ₂ᵤ=max(min((V_{U}−v)/aₑₛₜ, t_{d}−τ), 0),

t_{ub}=max(t_{d}−τ−yₐ₂ᵤ, 0).

At the decision time t_{D}, let the vehicle is located at the distance x_{D} to the stop line with the speed v_{D}, the expected time tt_{D} to the stop line is calculated as

X_{C}(tt_{D}, v_{D})−x_{D}=0, (6)

where tt_{D} can be found using a root-finding algorithm, e.g., the bisection method.

Some traditional decision strategies only work at the onset of yellow light, i.e., at t=0. If t_{D}>0, the information at t=0 can be estimated using the motion state at t_{D} as follows.

The expected time tt₀ and distance xₒ to the stop line at t=0 are respectively calculated as

tt₀=tt_{D}−t_{D}, (7)

x₀=x_{D}−X_{C}(t_{D}, v_{D}), (8)

and the expected speed v₀ at t=0 is calculated as

$${v}_{0} = \{ \begin{matrix}{v}_{D} , & IF mode is cruising , \\ \overline{v} , & IF mode is random , \\ min ( {V}_{U} , {v}_{D} + {a}_{est} \cdot max ( t - {T}_{CD} - τ , 0 ) ) , & IF mode is acceleration .\end{matrix} \qquad ( 9 )$$

### Decision Support Model

The decision support model (DSM) is essentially a decision making process on the binary choice set {stop, go}, i.e., to decide the vehicle to stop before the stop line or to go through the intersection.

A probabilistic sequential decision making process (PS-DMP) is used as the basic framework to realize DSM. PS-DMP contains an ordered list of sub-processes, i.e., [sp₁, . . . , spᵢ . . . sp_{M}], where each sub-process sp is described with a tuple (Decision Rule, Probability), or (Rule, Prob). Each decision rule (R) is selected to run in the probability, and it either selects an option in the choice set or returns null.

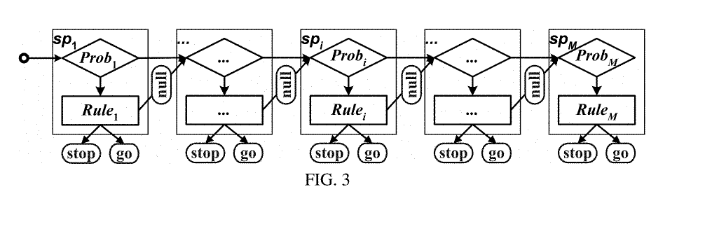

As shown in FIG. 3, PS-DMP runs through the sequence of its sub-processes from sp₁ to sp_{M}. For each sp, its decision rule instance is executed with its associated probability. Suppose the current sub-process is spᵢ, the total process is terminated if the current spᵢ returns a valid choice in the choice set. Otherwise, the process continues to execute the next sub-process spᵢ₊₁. One might specify a default output at the end of PS-DMP if the final decision rule still returns null.

PS-DMP is based on the bounded rationality used in the human cognitive and decision making process. Instead of developing a sophisticated decision rule to work in the high dimensional variable space, which might be very difficult, if not impossible, PS-DMP relies on combining a sequence of (fast and) frugal decision rules (or heuristics) tailoring to limited problem structure information. A decision rule with more certainty on some outputs, even as the decision rule might be very simple and only work in a small parameter space, can be executed with higher priority in the sequential structure. The modular design allows the DSM be continually improving through accumulating better decision rules and replacing obsolete decision rules in the existing sequence of PS-DMP.

The purpose of DSM is to ensure the safety while improving the efficiency. By safety, the vehicle should either stop behind the stop line or pass through the intersection with a lower probability in running the red light. By efficiency, the vehicle should encounter less expected delay at the intersection.

As an example, the time to execute the DSM, i.e., the decision time t_{D}, is set as t_{D}=T_{CD}, for making the best decision at the earliest time. Note that t_{D} can be at a time later in the decision period (−Y+τ, T_{CD}]. In practice, multiple decisions can be generated during the decision period. If a driver is distracted to ignore the first decision, the driver can still be supported by the later decisions.

### Decision Rules

Each decision rule R, takes the motion state (t_{D},x_{D}, v_{D}) at the decision time t_{D} as its main input variables, but might also use additional control variables. Most existing decision strategies in literature only work at t=0 (the onset of yellow). The present invention extends the work condition to t≤T_{CD}, and incorporates W, L, and SPaT information through integrating with the RLR definitions.

### Based on Clearing Distance

The decision rule R_{C} makes the decision to go, using the clearing distance information,

R_{C}(t_{D}, x_{D}, v_{D})=go, IF X_{C}^{C}−Xᵣₑₘ(x_{D})>ϵ_{C}, (10)

where the clearing distance X_{C}^{C}, is the continuation distance (Eq. 5) in the remaining time, i.e.,

X_{C}^{C}=X_{C}(Tᵣₑₘ(t_{D}), v_{D}), (11)

where Tᵣₑₘ and Xᵣₑₘ are respectively defined in Eqs. 1 and 2 for incorporating the RLR definitions, and ϵ_{C}≥0 is a small tolerance value.

There are a few advantages in the seamless integration of the decision rule R_{C} with the RLR definition. First, R_{C} can avoid potential violations in different RLR laws. Second, R_{C} can fully utilize the physical information (i.e., Y, R, W, and L) in the RLR definition to improve safety and mobility.

### Based on Stopping Distance

The decision rule R_{S} makes the decision to stop, if the expected distance to the stop line is no less than the critical stopping distance X_{C}^{C} at the decision time t_{D}, i.e.,

R_{S}(t_{D}, x_{D}, v_{D})=stop, IF x_{D}−X_{S}^{C}>ϵ_{S}, (12)

where ϵ_{S}≥0 is a small tolerance value, and X_{S}^{C} is the shortest distance of the vehicle to stop, i.e.,

X_{S}^{C}=X_{S}(v_{D},D), (13)

where D is the general comfortable deceleration rate in Eq. 3, and the stopping distance X_{S} for an initial speed v and an average deceleration rate \hat{d} is calculated as

$${X}_{S} ( v , \hat{d} ) = v \cdot τ + \frac{{v}^{2}}{2 \hat{d}} . \qquad ( 14 )$$

If the decision time is at t_{D}=0 (such as if T_{CD}=0 is used in our setting), then the R_{S} rule works as traditional methods that make the decision at the onset of yellow light.

### Based on Stopping Probability

The decision rule R_{P} makes the decision to stop, if the estimated stopping probability Pₛₜₒₚ at t=0 is larger than a threshold constant P_{TH} ∈ [0, 1], i.e.,

R_{P}(t_{D},x_{D}, v_{D})=stop, IF Pₛₜₒₚ>P_{TH}. (15)

The stopping probability Pₛₜₒₚ represents the probability of a vehicle to stop at the intersection based on a set of predictor variables. Two common-used methods used in existing work include logistic regression analysis and the model based on the concept of critical time.

Typical field data can be fit using the logistic regression, i.e.,

Pₛₜₒₚ^{LR}=[1+exp(−Kₛₜₒₚ)]⁻¹, (16)

where Kₛₜₒₚ is the logit of the logistic function.

The logit for predicting the Pₛₜₒₚ of the travel time to the stop line tt₀ is represented as

Kₛₜₒₚ^{TT}=β₀^{TT}+β₁^{TT}·tt₀, (17)

where the coefficients β₀^{TT}=−6.34 and β₁^{TT}=1.69.

The logit in VISSIM with the variables v₀ and x₀ is represented as

Kₛₜₒₚ^{VX}=β₀^{VX}+β₁^{VX}·v₀+β₂^{VX}·x₀, (18)

where the coefficients β₀^{VX}=0.798, β₁^{VX}=−0.35 and β₂^{VX}=0.455, as calibrated from field data.

Some logit-based versions also include more predictor variables, such as the length of Y, age group, aggressiveness and distraction status of the driver, vehicle type, presence of adjacent go-through vehicle(s), presence of side-street vehicles/pedestrians/bikes, and road surface conditions, etc.

The stopping probability can also be estimated using the concept of critical time. There is an assumption that each driver has his own critical time T_{cr} reflecting his experience and characteristics, such as his driving skills and aggressiveness, his expectancy to the length of Y, and his perception of acceleration rate a. Let TT₀ be a driver's perception of tt at t=0. Both TT₀ and T_{cr} are assumed to be normally distributed among drivers, i.e., TT₀˜N(tt₀, σ_{ξ}²) and T_{cr}˜N(t_{cr}, σ_{ϵ}²), where t_{cr} is the mean value of T_{cr}. The stopping probability Pₛₜₒₚ is then calculated as

Pₛₜₒₚ^{CT}=Φ((tt₀−t_{cr})/σ), (19)

where σ=\sqrt{σ_{ξ}²+σ_{ϵ}²−2σ_{ξ,ϵ}}, σ_{ξ,ϵ}is the covariance of TT₀ and T_{cr}, Φ denotes the cumulative normal distribution function (CNDF), and t_{cr} is formulated in terms of v₀, i.e.,

t_{cr}=β₀^{CT}+β₁^{CT}·v₀, (20)

where β₀^{CT}=3.90 and β₁^{CT}=0.028, with σ²=2.40 in Eq. 19.

### Implementation of DSM

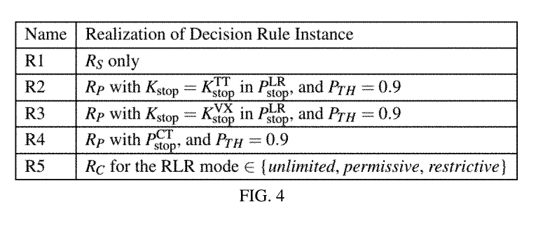

The implementation of DSM in PS-DMP proceeds with two steps. The first step is to define a list of decision rule instances, where each instance has a unique name to be called later. FIG. 4 lists several decision rule instances as examples. Herein R1 and R5 are based on physical models, whereas R2, R3 and R4 are based on data-driven fitting models.

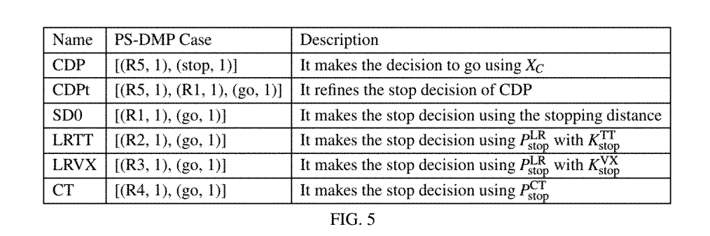

The second step is to define PS-DMP cases, where each case can be seen as a stand-alone DSM, based on the decision rule instances defined in the first step. FIG. 5 lists several PS-DMP cases as examples.

Let us take CDPt as an example to describe the execution of PS-DMP. For sp₁=(R5, 1), it executes R5 with a probability of 1. The total process is terminated if spᵢ decides to go. Otherwise the process execute the next sp, i.e., (R1, 1). The process is terminated if R1 decides to stop. The last sp might be considered as the default decision if every previous sub-process returns null.

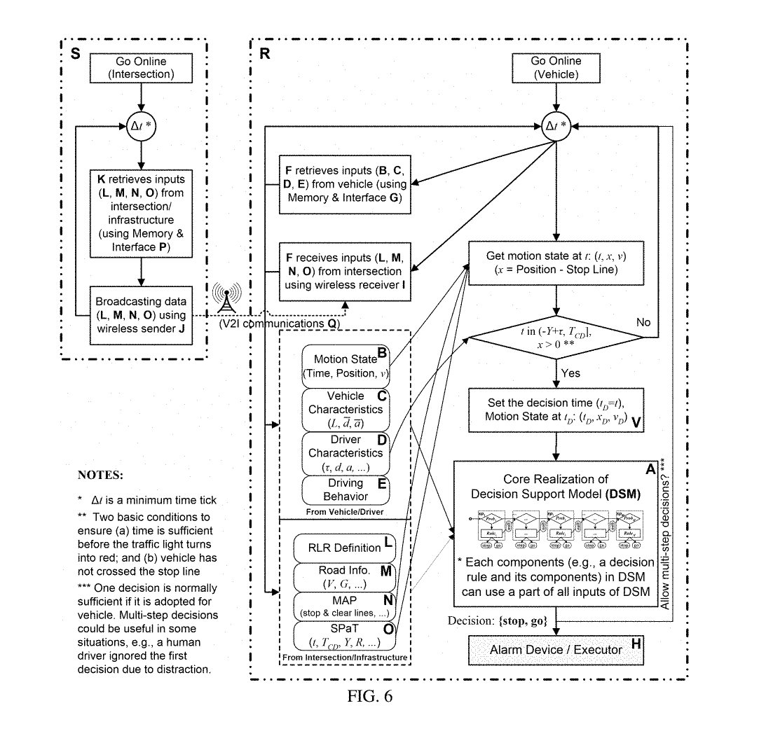

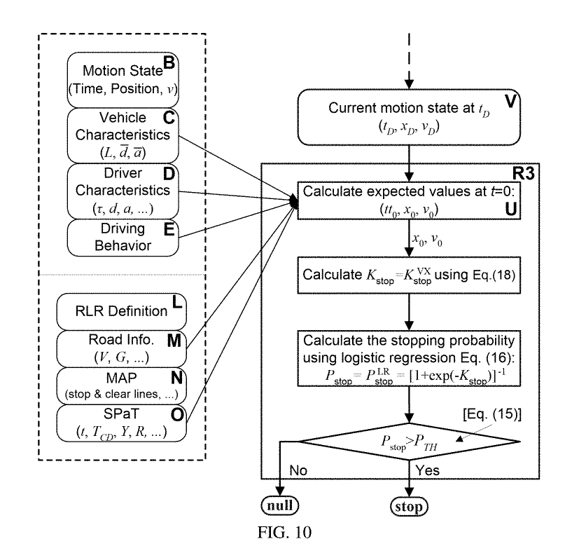

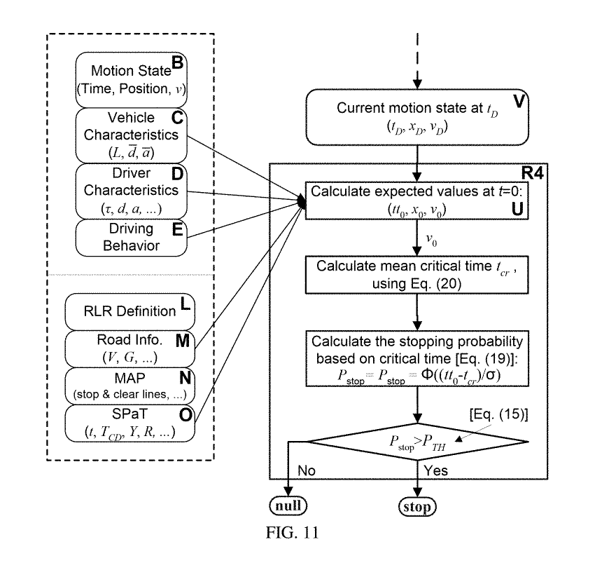

### Flowcharts of SIV-DSS—FIG. 6-FIG. 13

FIG. 6 shows the flowchart for the system described in FIG. 2. Upon the decision to take online, the system iteratively runs with small time ticks (e.g., Δt=0.1 s). At each tick, the system takes following actions. On the side of intersection/infrastructure S, intersection-side processor K maintains and retrieves the inputs comprising RLR definition L, road information M, MAP information N and SPaT information O, using its memory and the intersection/infrastructure interface P. These inputs (i.e., L, M, N, O in FIG. 2) are broadcasted to vehicles using the wireless sender J. One the side of vehicle R, there are three actions. First, vehicle-side processor F maintains and retrieves the inputs from vehicle using its memory and the in-vehicle sensor interface G, which comprise raw vehicle motion state B, vehicle characteristics C, driver characteristics D and driving behavior E (see FIG. 2). Second, vehicle-side processor F receives the inputs from wireless sender J of intersection/infrastructure S (i.e., L, M, N, O in FIG. 2), using wireless receiver I through V2I communications Q. Third, vehicle-side processor F starts a decision process using all inputs comprising B, C, D, E, L, M, N and O. The relative motion state at t, i.e., (t,x, v), is obtained using B, N and 0. The system then checks basic conditions. If t ∈ (−Y+τ, T_{CD}] and x>0, the system sets the decision time as t_{D}=t, and gets the motion state (t_{D},x_{D}, v_{D}) at t_{D} (V in FIG. 6). Decision support model (DSM) A then makes a decision {stop, go} based on all available inputs (including V, B, C, D, E, L, M, N, O). In the core realization of DSM, each component (e.g., any decision rule or its components) of DSM can use any part of these inputs.

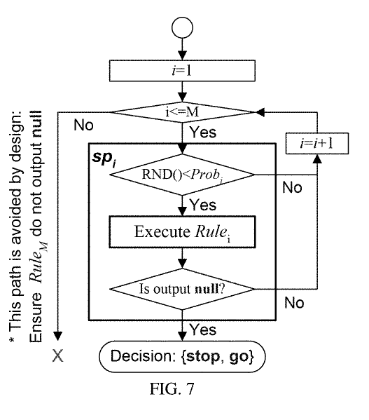

FIG. 7 shows the flowchart for the PS-DMP realization of DSM described in FIG. 3. In order to output a valid decision, the path X has been avoided by design, meaning that there is at least one decision rule (i.e., M>0) in PS-DMP, and the last decision rule (i.e., Rule_{M}) should not output null.

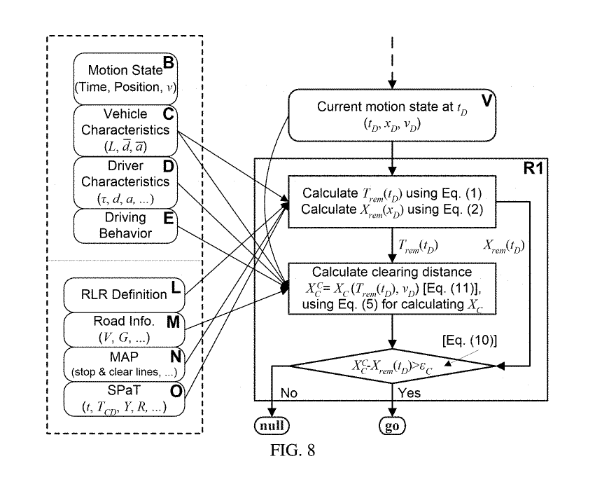

FIG. 8 to FIG. 12 give the flowcharts for the examples of the rule instances in FIG. 4. All these rules can access all inputs of the DSM in FIG. 6. The flowchart of R1 is described in FIG. 8. It first calculates Tᵣₑₘ(t_{D}) and Xᵣₑₘ(x_{D}) using Eqs. 1 and 2 using inputs C, L, N, O, and V. Then it calculates the clearing distance X_{C}^{C} using Eq. 11, based on the model of continuation distance X_{C} defined in Eq. 5, using the inputs C, D, E, M, V. Finally, R1 returns go if the condition in Eq. 10 is satisfied, otherwise it returns null.

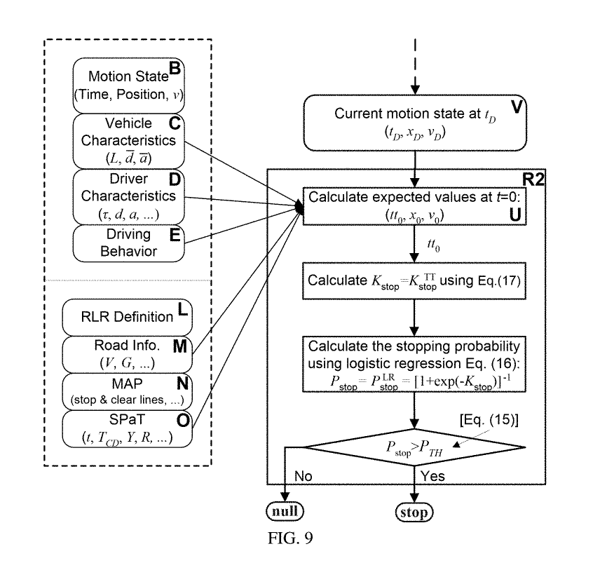

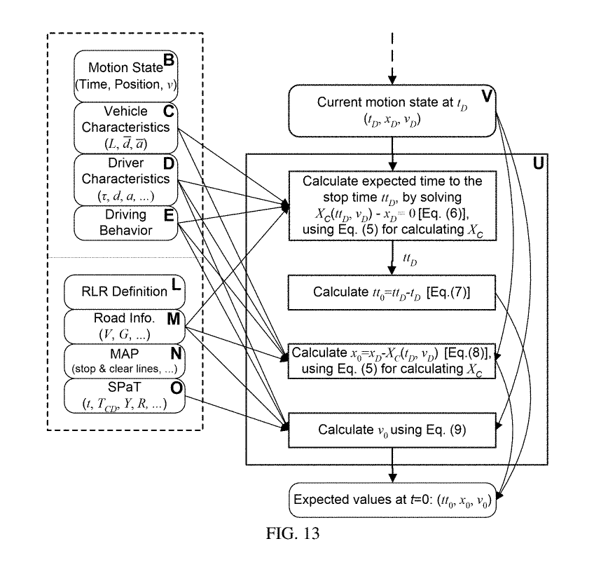

The flowcharts of R2, R3, R4 are described in the figures from FIG. 9 to FIG. 11. The three decision rules only work at the onset of yellow light, i.e., at t=0. They have a same component U that calculates the expected motion state (tt₀, x₀, v₀) at t=0, as described in FIG. 13. In the component U, the expected time to the stop line tt_{D} is first calculated by solving Eq. 6, based on the model of continuation distance X_{C} defined in Eq. 5, using the inputs C, D, E, M, V. Then tt₀ is obtained using Eq. 7. The value of xₒ is calculated using Eq. 8 using the X_{C} model, using the inputs C, D, E, M, V. The value of v₀ is calculated using Eq. 9, using the inputs D, E, M, 0, V. In total, the component U uses the inputs C, D, E, M, O, V.

For decision making, the three decision rules use a similar condition as described in Eq. 15, which returns stop if the condition is satisfied, otherwise returns null. The difference between them is in the ways of calculating the stopping probability Pₛₜₑₚ. Both R2 and R3 use logistic regression in Eq. 16, but their logits are respectively calculated using Eqs. 17 and 18. R4 first calculates the critical time t_{cr} using Eq. 20, then calculates the stopping probability based on the cumulative normal distribution function (CDNF) in Eq. 19.

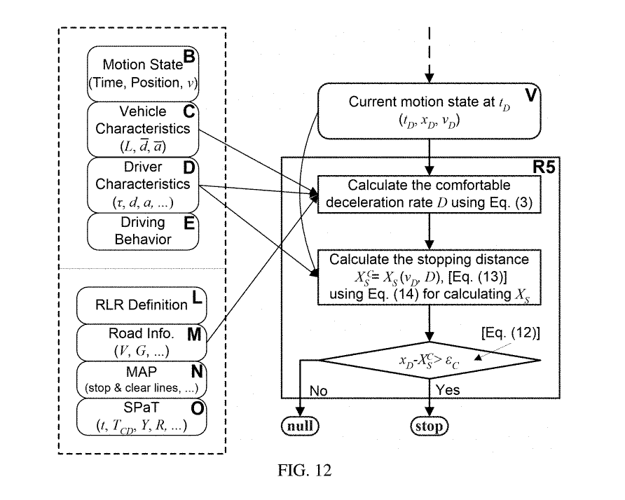

The flowchart of R5 is described in FIG. 12. It first calculates the comfortable deceleration rate D using Eq. 3 and the inputs C, D, M, V. Afterwards, it calculates the shortest stopping distance X_{S}^{C} using Eq. 13, based on the generic stopping model in Eq. 14 and using the inputs D and V. Finally, it returns the decision stop if the condition in Eq. 12 is satisfied, otherwise it returns null.

### System Development

The performance of SIV-DSS is evaluated with simulation experiments. In the experiments, the speed v of each vehicle is initialized stochastically using a truncated normal distribution in the bounded range of [V_{L}, V_{U}], where V_{L}=V·(1−rᵥ), and V_{U}=V·(1+rᵥ). The distance from each vehicle position to the intersection x is set as v·\tilde{t}t, where \tilde{t}t can be interpreted as the time to the stop line (TTSL) in the cruising mode. The remaining green time t is initialized at random in the range of [0, \tilde{t}t]. The experimental setting makes indecisions and inappropriate decisions frequently occur, thus enable us to focus our study of the decision making characteristics on the indecision zone of the decision support system. The default simulation settings are rᵥ=0.2 and \tilde{t}t=10 s. The simulation updates the vehicle motion state in the ticks with a tick interval of 0.1 s. For any vehicle which cannot successfully stop behind the stop line, they have to pass through the intersection with a comfortable acceleration, in order to avoid stopping in the middle of an intersection. For the V2I communication, we assume there is 100% success rate with no delay. Note that any communication delay and failures and the time for executing the system can be factored into PRT. For each test, the statistical results of 10000 vehicles are reported.

In the default testing scenario, the basic parameters include W=25 m, L=5 m, Y=5.5 s, R=2 s, T_{CD}=0 s, V=55 mph≈24.59 m/s, G=0%, τ=2.5 s, d=3 s, and the drive behavior is in the cruising mode. The default T_{CD} is set at the onset of yellow, as used in the traditional dilemma zone studies.

For R2, R3, and R4, the parameter P_{S}=0.9 is used to trigger the stop decision of a vehicle as Pₛₜₒₚ>P_{S}. In other words, the vehicle should stop if it is neither in the clearance zone nor in the dilemma zone (DZ), based on a commonly-used DZ definition that refers to the boundaries of DZ as Pₛₜₒₚ ∈ [0.1, 0.9]. For the three rules, let us take an example to use the default coefficients in existing models (as described in Section 111), i.e., respectively the logistic models and the critical time model. The three existing models are respectively embedded in LRTT, LRVX, and CT, which can be regarded as baseline models.

Due to the wide parameter ranges for driver characteristics, let us test τ ∈ [0.5, 2.5] seconds to consider response time from autonomous vehicles and human drivers, and d ∈ [2,6] m/s² to include deceleration rates in different road conditions. As an associated parameter for the comfortable deceleration in Eq. 3, the range [−10%, 10%] is used for G. For a, let us take an example to use the model in Eq. 4 with default parameter values for passenger vehicles. Note that a is only used in the acceleration mode of driving behavior model (Eq. 5).

According to FHWA, normally the durations of yellow change interval Y and red clearance interval are respectively Y ∈ [3, 6] seconds and R≤6 seconds. In our test examples, we consider Y ∈ [3.5, 7.5] seconds and R ∈ [1,5] seconds. Here Y is set longer than the conventional range in order to evaluate the condition without Type-I dilemma zone. For driving speed, we consider the wide range of [35, 75] mph as an example.

### Basic Performance

First, the DSM results are reported for the three RLR modes on the proportions (in percentages) of the stops (pStop), of the successful passes (pPass), and of the passes with RLR violation (pRLR) respectively. By safety, the pRLR in the results should be as close to 0 as possible. By efficiency, the pStop should be as low as possible in order to reduce the vehicle delay at the intersection. The basic relation is

pStop+pPass+pRLR=1. (21)

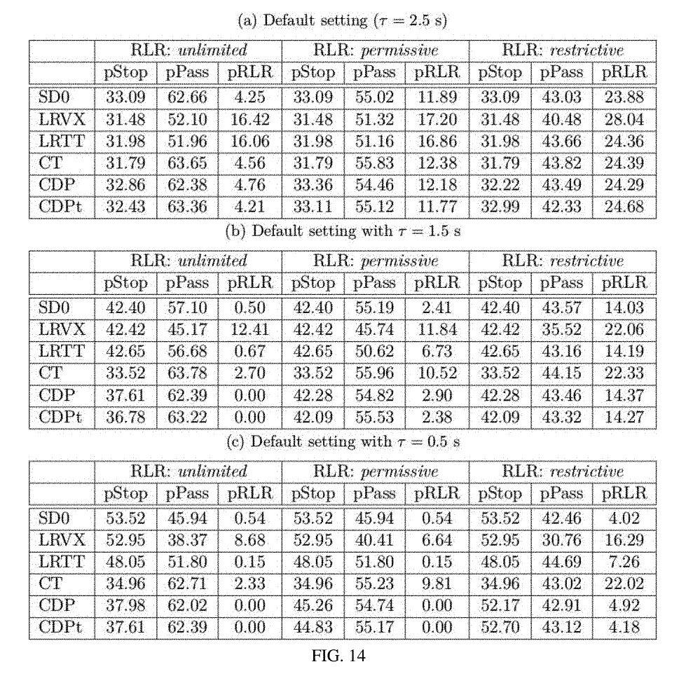

FIG. 14 reports the results of our DSM using the default parameters and variants. The τ=2.5 s is a conservative value referred from the standard of AASHTO. The τ=1.5 s is referred from the case for human drivers with in-vehicle vocal and visual alarming. The τ=0.5 s is chosen according to the rapid response time of the autonomous vehicles capable of tolerating a few V2I communication failures.

Herein performance of DSMs is examined. SD0 obtains low pStop and pRLR results as τ=2.5 s or RLR is restrictive, but its pRLR becomes rather high in the cases with τ ∈ {1.5, 0.5} s and RLR ∈ {permissive, unlimited}. It is due to that pRLR cannot fully utilize the extra time saved with a lower τ and a less restrictive RLR definition. LRVX obtains a low pStop as τ=2.5 s, but the pStop becomes rather high as τ ∈ {1.5, 0.5} s. For LRVX, its pRLR remains high in all settings, thus it needs the protection from all-red extension. The results of LRTT are quite similar to those of LRVX as τ=2.5 s. As τ increases, the pStop of LRTT becomes high, although the pRLR of LRTT decreases significantly. SD0 obtains low pStop and pRLR results as τ=2.5 s or RLR is unlimited, but its pRLR becomes high in the cases with τ ∈ {1.5, 0.5} s and RLR ∈ {permissive, restrictive}. In other words, the four DSMs (SD0, LRVX, LRTT, and CT) need to be re-calibrated in different settings. Compared with the four DSMs, both CDP and CDPt models obtain low results on both pStop and pRLR in all the cases with different settings.

For all the DSMs, the pRLR value is reduced when τ decreases. For τ=2.5 s (see FIG. 14(a)), no model is able to achieve the exact 0% pRLR using the default setting, due to the existence of the yellow light dilemma zone. For τ=1.5 s (see FIG. 14(b)), the CDP and CDPt models both achieve pRLR=0 and obtain high pPass values in the unlimited RLR mode, due to the usage of Y and R. For τ=0.5 s (see FIG. 14(c)), the CDP and CDPt models achieve pRLR=0 and obtain high pPass values in both the unlimited and permissive RLR modes, due to the usage of Y.

For a vehicle trapped in the dilemma zone, CDP would at first make a decision of stop, resulting in an attempt to stop the vehicle, and then have to accelerate later after running into the intersection. Such a hesitant decision making is a well-known risk, since it prolongs the time into red. Even as a vehicle trapped in the dilemma zone, the decision is more confident with CDPt, and the vehicle can be protected with a much shorter all-red extension, if it cannot stop and has to run the red light.

### Comparison Between CDP and CDPt

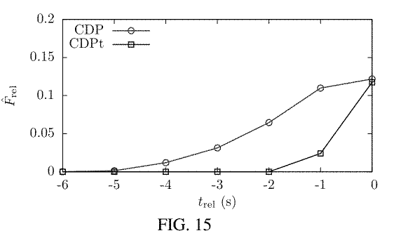

CDP and CDPt have the similar results on pRLR and pStop, as shown in FIG. 14. For a better display of the difference between CDP and CDPt, FIG. 15 gives the cumulative distribution function \hat{F}ᵣₑₗ related to RLR violation in the permissive RLR mode for the vehicles passing through the intersection at different time. For each DSM, the average duration of RLR violation is the area under the \hat{F}ᵣₑₗ curve with tᵣₑₗ<0. Compared to using CDPt, the result with CDP thus have a longer duration of RLR violation on average, as shown in FIG. 15. The longer duration of a RLR violation, the higher probability of a traffic crash.

For a vehicle trapped in the dilemma zone, CDP would at first make a decision of stop, resulting in an attempt to stop the vehicle, and then have to accelerate later after running into the intersection. Such a hesitant decision making is a well-known risk, since it prolongs the time into red. Even as a vehicle trapped in the dilemma zone, the decision is more confident with CDPt, and the vehicle can be protected with a much shorter all-red extension, if it cannot stop and has to run the red light.

Results of CDPt with Different Driving Behavior Modes

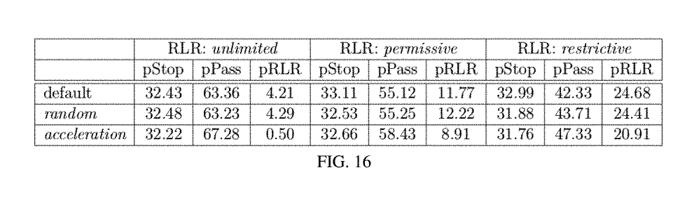

FIG. 16 gives the results of CDPt with different driving behavior modes. In comparison with the cruising mode, the random mode introduces randomness in the speed of vehicle. Interestingly, CDPt returns similar results for the cruising and random modes, meaning that CDPt is robust on handling randomness. As shown in FIG. 16, the CDPt model works the best in the acceleration mode, where the pRLR value is significantly reduced and the pPass value is largely increased, compared to the other two modes. However, it should keep in mind that the acceleration mode must be well-controlled to avoid speeding and aggressive driving.

Results of CDPt with Different SPaT Parameters

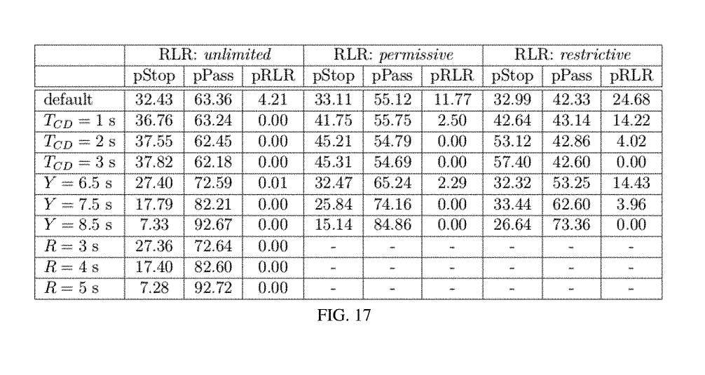

FIG. 17 reports the results of the CDPt model with different T_{CD}, Y, and R values, to be compared with the default setting of T_{CD}=0 s, Y=5.5 s, and R=2 s. These SPaT parameters are used for traffic control to adjust the impact on the aspects of safety and mobility at the intersection.

The first impact is on the safety aspect. The results show that as T_{CD} is increased, pRLR is significantly reduced. There is no violation in all RLR modes when T_{CD} is increased to 3 s. This means that by using a sufficient long T_{CD}, the decision rule R1 in CDPt can stop vehicles to be trapped into the dilemma zone. As Y and R are increased, the pRLR values reduce as well. The strategy of increasing R only works for the unlimited mode, and it can be seen as an all-red extension strategy for the dilemma zone protection.

The second impact is on the mobility aspect. As Y and R are increased, the pPass values also rise significantly. However, it should keep in mind that a long intergreen time (Y+R) imposes excessive delay for the anticipated queue of vehicles on all entry roads before the phase switches back. Thus, there is an adaptive tradeoff when varied Y and R are used to improve mobility in different flow conditions.

### Boundary Conditions for RLR Violations

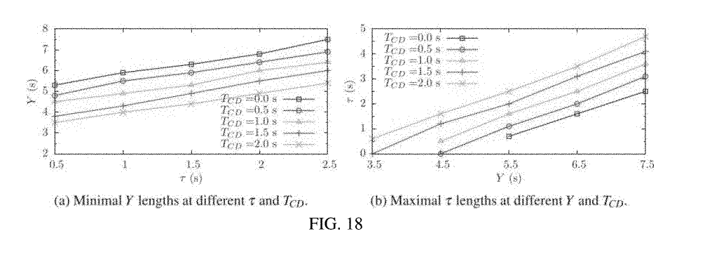

SIV-DSS can serve as an analysis tool for achieving robust intersection management and improving indecision zone protection and road safety. FIG. 18 shows two examples that use CDPt to find the boundary conditions of zero RLR probability, where each bound value is obtained with the bisection method. FIG. 18a gives an example of finding minimal Y lengths at different τ and T_{CD}. As shown in the figure, Y can be shorter if T_{CD} is longer or τ is shorter. For a specific intersection, its traffic operator can use this information to set a fair Y length to ensure road safety based on the available T_{CD} and a given percentile of the population-based statistics of τ. FIG. 18b shows an example of finding maximal τ lengths at different Y and T_{CD}. As shown in the figure, τ can be longer if T_{CD} or Y is longer. This information can be used to provide the confidence level of decision to individual drivers given the individual-based statistics of τ is available. The importance of τ in decision making gradually decreases with the increase of T_{CD} and can diminish to zero.

### Characteristics of the Decision Support Model CDPt

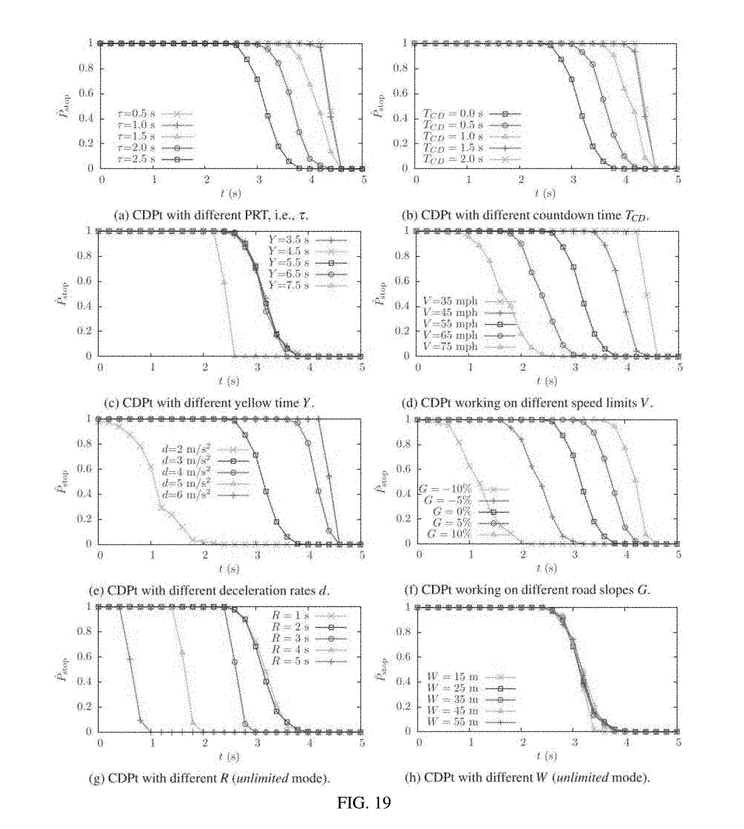

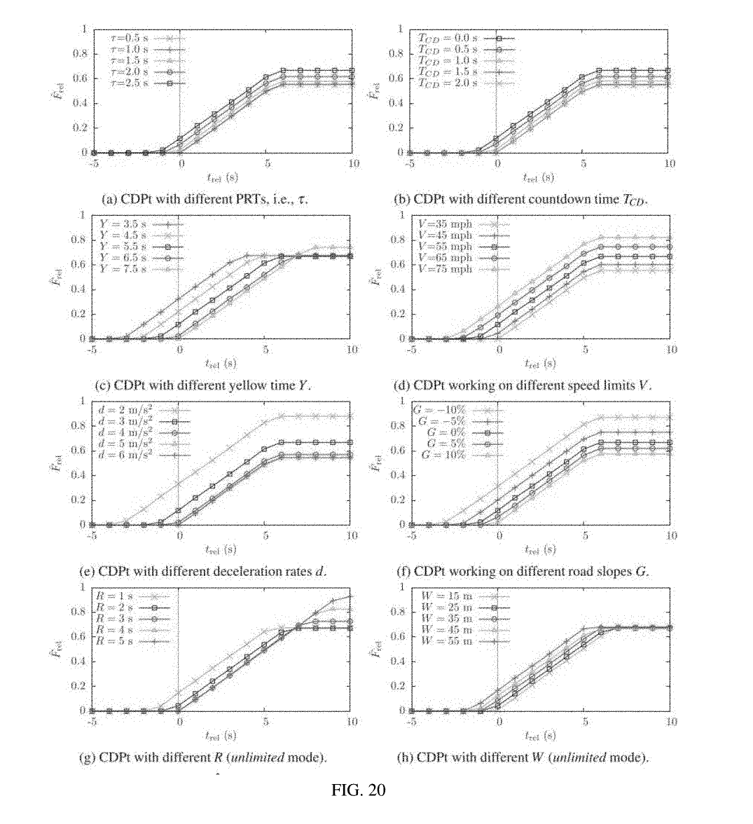

FIG. 19 shows the actual stopping probability \hat{P}ₛₜₒₚ (t) for the vehicles approaching the intersection at different remaining green time t, when using the CDPt model with different settings. FIG. 20 shows the cumulative distribution function \hat{F}ᵣₑₗ of the CDPt model using different settings for the vehicles passing through the intersection at different relative time, i.e., tᵣₑₗ. Notice that if tᵣₑₗ is negative, its absolute value is the duration of RLR violation. Herein all the settings work in the permissive RLR mode, except for the tests on R (FIG. 19g and FIG. 20g) and W (FIG. 19h and FIG. 20h) working in the unlimited mode. Based on the RLR definition, R, W and L do not have any impact in the permissive mode.

Other Aspects to Cope with Real World Implementations

### Parameter Space and Learning

For SIV-DSS, key inputs include a, d, τ, V, R, Y, T_{CD}, W, L, G, the RLR mode, and the driving mode (see FIG.). Most of these inputs, including R, Y, T_{CD}, W, L, G and the RLR mode, are physical parameters known for each specific vehicle and intersection. These parameters are made accurately available through V2I communications. In traditional drivings, however, drivers does no know exactly and thus cannot utilize most of these input information. There are two important implications to know these inputs accurately. First, SIV-DSS can more likely reach the generality through physical models utilizing a large number of accurate physical parameters in the parameter space. Second, SIV-DSS can handle the heterogeneity from the perspective of specific vehicles and intersections.

The speed of the vehicle can be quite steady under cruise control, but might have some additional noises under manual control by human drivers. As shown by the comparison between the default (without noise) and the random (with random noise) driving modes in FIG. 16, the impact of noises is not significant on outputs. In real time, the speed can be estimated quite accurately through the fusion of the data from CAN bus and GPS. High-precision GPS is already in the on-board unit of a connected vehicle, and super-accurate GPS (e.g., 30-centimeter accuracy) will come to smartphones very soon. For estimating average speed, the significance of GPS accuracy is gradually reduced with the increase of driving distance, and finally there is no notable impact from GPS accuracy after driving a sufficient long distance.

The remaining inputs include the driver characteristics, i.e., a, d, and τ (see FIG.). Although these inputs can be precisely controlled for autonomous vehicles, they can have quite heterogeneous statistical distributions among individual human drivers. On personalized estimation for individual drivers, we can choose the collective distribution at a population level as an initial estimation, and then optimize it by augmenting personalized distributions through gradually collecting individual driving experience of each driver. τ is used both for stopping at the intersections and for passing through the intersection with the acceleration mode. d is used only for stopping at the intersection. If T_{CD} increases, CDPt can make the stop decision earlier; and the importance of τ and d in making the stopping decision can gradually diminish to zero with the increase of T_{CD}. a is only used for passing through the intersection with the acceleration mode. For road safety, the acceleration mode is only suitable for autonomous vehicles or the vehicles driven by highly experienced drivers who can more precisely control safe speed during the acceleration process. Thus, no sensitivity analysis is performed on α in the acceleration mode.

Individual driving experience can be learnt while SIV-DSS is in use. Each τ can be collected as t_{P}−t_{D} if the driver follows the decision of SIV-DSS, where t_{D} is the decision time, and t_{P} is the time that the driver started to press the brake or gas pedal respectively in stopping or acceleration. The average deceleration rate \hat{d} can be obtain by examining the deceleration processes for each full stop. The accelerate rate a can be analyzed from the motion states when the driver follows the go decision in the acceleration mode.

### Decision Rules in SIV-DSS

In the sequential process of PS-DMP, the current decision can be influenced by its previous ones in an indirect way. Let A be the whole parameter space, and Aᵢ be the subset of A that makes the sub-process spᵢ return a non-null decision. As long as spᵢ is executed, Aᵢ will be subtracted from A in the parameter space that is considered by any sub-process executed later than spᵢ. For any two adjacent sub-processes spᵢ and spᵢ₊₁, if Aᵢ∩Aᵢ₊₁≡∅, spᵢ and spᵢ₊₁ can exchange their execution orders without any effect on outcome. However, if Aᵢ∩Aᵢ₊₁≠∅, spᵢ and spᵢ₊₁ can not exchange their execution orders, otherwise different results would be produced; the parameter space Aᵢ∩Aᵢ₊₁ is executed by spᵢ rather than spᵢ₊₁ in this case.

For two generic rules respectively in spᵢ and spⱼ, it is difficult to find out whether Aᵢ∩Aⱼ≡∅ or Aᵢ∩Aⱼ≠∅ purely based on the analytical expressions. For two related rules of PS-DMP in spᵢ and spⱼ, however, we can judge it according to the results. As an example, here let R1 and R5 of PS-DMP be respectively in spᵢ and spⱼ, we show the method proving Aᵢ∩Aⱼ≠∅ from the results using an existence proof by contradiction. Assume Aᵢ∩Aⱼ≡∅, then (R1, 1) and (R5, 1) can exchange their execution orders in CDPt, which leads to CDPt =[(R5, 1), (R1, 1), (go, 1)] [(R1, 1), (R5, 1), (go, 1)]. Notice that [(R5, 1), (go, 1)] [(go, 1)] because R5 can only return {go, null}. Therefore, if Aᵢ∩Aⱼ≡∅, CDPt=[(R5, 1), (R1, 1), (go, 1)]≡[(R1, 1), (R5, 1), (go, 1)]≡[(R1, 1), (go, 1)]=SD0. However, significantly different results have been found between SD0 and CDPt (see Table FIG. 14). Based on the existence proof by contradiction, Aᵢ∩Aⱼ≠∅ is thus proven to be true for R1 and R5 respectively in spᵢ and spⱼ.

The parameter space Aᵢ∩Aⱼ regarding R1 and R5 respectively in spᵢ and spⱼ represents a condition space for Type-II indecision zone where both stop/go decisions can be made. In PS-DMP, the “stop” decision will be made if R1 is executed first, while the “go” decision will be made if R5 is executed earlier. In the case of Aᵢ∩Aⱼ≢∅, a correct sequence to execute decision rules is important. Again as an example, in CDPt, R5 has to be placed before R1 in the execution sequence as the vehicle should be advised to go rather than stop unnecessarily in this case.

In this invention, each decision rule is independent from others on its own decision making. Given any dependence or direct influence among some different decision rules was needed to consider, a macro rule (e.g., weighted voting or if-clauses) could be used for integrating the multiple rules into one rule.

There is no limit on how many rules should be used in PS-DMP. Usage of more rules may refine some corner cases. For example, in CDPt, R1 is used to refine the stop decision of CDP. However, it should be mentioned that if too many rules were used, the decision model might be overfitting and the decision process might be more difficult to be human interpretable. Compared to the simple if-clauses (which is commonly used in a decision tree), each decision rule (node) in PS-DMP can be used to treat more sophisticated problems such as making decisions in a nonlinear space through including parametric and physical models. Parametric models are required to be calibrated from field data. The incorporation of accurate physical models with accurate parameters can also help improving the generality of PS-DMP implementation.

### More Aspects Relevant to Practical Implementations

SIV-DSS is proposed for improving mobility while ensuring safety, based on different permissions on the use of Y and R under the constraint of the law (regarding the RLR definitions). We showed the impacts of the two settings of SPaT parameters on the aspects of safety and mobility at an intersection. The widely used permissive yellow law allows a driver to use the entire period of Y. The unlimited mode allows a driver to use the both entire periods of Y and R. However, it is always more rational in practice to keep a sufficient safety margin for drivers to tolerate some potential errors, rather than to consider fully using the entire time of Y and R by drivers, even if the usage is permitted by law. In SIV-DSS, there are a few ways to add a safety margin for drivers. For example, Y can be replaced by Y′=Y−δY in Eq. 1, where δY≥0 is used as the safety margin for further reducing the RLR probability and the related risk to traffic crashes.

Using SIV-DSS as an analysis tool, a few boundary conditions for RLR violations have been investigated. If T_{CD} is sufficiently long, pRLR can be reduced to 0 even as Y and R are short. This property can help reserve more time as the safety margin for drivers. If SIV-DSS could be combined with law enforcement, it would make the evaluation of enforcement more fair for road users on RLR violations. RLR violations at an intersection can be caused by different reasons. Some violations could be caused by aggressive driving behaviors, on which enforcement would definitely need to be put. Some other violations however could be due to improper SPaT settings. For example, because the yellow times were too short, the implementation of automated enforcement cameras at some intersection had brought serious opposition. In this case, engineering efforts would be needed to adjust SPaT parameters. In addition, for the enforcement, if aggressive driving behavior could be targeted more precisely (for which SIV-DSS might be helpful), the implementation of automated enforcement would receive much less opposition. Some other violations could also be caused by unusual vehicle-driver characteristics, such as heavy vehicles with low deceleration rates. The all-red extensions might be helpful for providing protection in this case.

The stop/go decisions made by SIV-DSS can be directly executed by autonomous vehicles or be sent to human drivers normally through vocal and visual messages. It is an interesting research topic on how to effectively deliver the warning messages to human drivers. To prevent a driver from intentionally ignoring the warning message for a stop decision, the penalty information (e.g., fines and points) associated with a RLR violation and the related risk to traffic crashes can be provided to the driver.

The V2I communications can enable an intersection to collect some aggregated information from vehicles. Supported by V2I communications, population-based statistics of driving behavior characteristics can be obtained from vehicles passing an intersection, either by analyzing vehicle motion states or by summarizing individual driving experiences. Furthermore, if some vehicle identification information could be provided, automated enforcement on RLR violations would be implemented even without red-light cameras. The aggregated information could also be available for V2X applications. Of course, a precondition for the implementation is that information security must be enforced to protect the private vehicle identification information from any unauthorized access.

The present invention has been described in accordance with several examples, which are intended to be illustrative in all aspects rather than restrictive. Thus, the present invention is capable of many variations in detailed implementation, which may be derived from the description contained herein by a person of ordinary skill in the art.

The foregoing descriptions and figures should be considered as illustrative only of the principles of the invention. Various changes and modifications of the invention could have been readily made therein without departing from the spirit and scope of the embodiments by those skilled in the art. Therefore, it is not desired to limit the invention to the specific examples disclosed or the exact construction and operation shown and described. Rather, all suitable modifications and equivalents may be resorted to, and falling within the scope of the invention.

What is claimed:

1. A smart in-vehicle decision support system for making decisions to stop or go as a vehicle approaches a signalized intersection before and during a signal transition period, comprising the steps of:
providing a vehicle-side processor to collect and maintain inputs comprising vehicle motion state, vehicle characteristics, driver characteristics and driving behavior from vehicle and driver by using an in-vehicle sensor interface;
providing an intersection-side processor to collect and maintain inputs comprising intersection geometry and topology, signal phase and timing, road information, and red-light running definition from intersection/infrastructure by using an intersection/infrastructure interface;
transmitting inputs from intersection/infrastructure to the vehicle-side processor using vehicle-to-infrastructure communications between a wireless sender and a wireless receiver;
executing a decision support model in the vehicle-side processor at a decision time to generate decision support for vehicle to stop or go, using the inputs from vehicle and intersection/infrastructure; and
providing decision support for vehicle to stop or go through an alarm device/executor module.

2. The method according to claim 1, wherein the decision support model handles key physical and behavioral parameters comprising:
the vehicle length L in vehicle characteristics;
the perception-reaction time, the comfortable acceleration rate a and deceleration rate d on level pavement in driver characteristics;
the driving mode in driving behavior;
the speed limit V and the grade of the approach road G in road information;
the intersection width W according to intersection geometry and topology;
the green countdown time T_{CD}, the yellow change interval Y, the all-red clearance interval R in signal phase and timing; and
the red-light running definition.

3. The method according to claim 1, wherein the earliest decision time is at the green countdown time before the onset of yellow indication.

4. The method according to claim 3, wherein the latest decision time is the perception-reaction time before the end of yellow indication.

5. The method according to claim 1, wherein the decision support model is realized with a probabilistic sequential decision making process to execute one or more decision rules, where each decision rule is responsible to make a decision of {stop, go, null} for a specific situation, except for the last one only returns a decision of {stop, go}.

6. The method according to claim 5, wherein the decision rules comprise rules based on physical models and/or data-driven fitting models for making decisions.

7. The method according to claim 5, wherein the decision rules comprise rules based on clearing distance, stopping distance, and stopping probability.

8. The method according to claim 5, wherein one or more of the decision rules makes the decision to go, based on the clearing distance in the remaining time according to the red-light running definition for preventing red-light violation.

9. The method according to claim 5, wherein one or more of the decision rules makes the decision to stop, if the expected distance to the stop line is no less than the critical stopping distance at the decision time.

10. The method according to claim 5, wherein the probabilistic sequential decision making process comprises:
a decision rule making the decision to go based on the clearing distance in the remaining time according to the red-light running definition for preventing red-light violation, and returns null if the condition to go is not satisfied; and
a decision rule making the decision to stop if the expected distance to the stop line is no less than the critical stopping distance at the decision time, and returns null if the condition to stop is not satisfied.

11. The method according to claim 1, wherein signal phase and timing are retrieved through an intersection/infrastructure interface comprising a traffic controller.

12. The method according to claim 1, wherein vehicle motion state is retrieved through an in-vehicle sensor interface comprising a Global Positioning System in vehicle.

13. The method according to claim 12, wherein the vehicle-side inputs are fused with additional data through an in-vehicle sensor interface comprising a Controller Area Network of vehicle.

14. The method according to claim 1, wherein realization of vehicle-to-infrastructure communications comprises dedicated short range communications and 4G/LTE/5G cellular mobile communications.

15. The method according to claim 1, wherein red light running definition comprises restrictive, permissive, unlimited modes.

16. The method according to claim 1, wherein driving behavior comprises cruising, random, acceleration modes.

17. The method according to claim 1, wherein red light running definition uses inputs comprising: the vehicle length L in vehicle characteristics; the yellow change interval Y, and the all-red clearance interval R in signal phase and timing; and the intersection width W in intersection geometry and topology.

18. The method according to claim 1, wherein the decision support model can be used as an analysis tool for identifying boundary conditions for red-light running violations in different intersection configurations.
